(19) United States
(12) Patent Application Publication
(10) Pub. No.: US 2021/0334227 A1
(43) Pub. Date: Oct. 28, 2021

(54) SYSTEMS AND METHODS OF CONVEYING INFORMATION IN A VEHICLE ACCORDING TO A HIERARCHY OF PREFERENCES

(71) Applicant: Toyota Motor Engineering & Manufacturing North America, Inc., Plano, TX (US)

(72) Inventor: Sean L. Helm, Saline, MI (US)

(73) Assignee: Toyota Motor Engineering & Manufacturing North America, Inc., Plano, TX (US)

(21) Appl. No.: 16/857,630

(22) Filed: Apr. 24, 2020

(51) Int. Cl. G06F 13/22; G07C 5/08; B60K 35/00

(52) U.S. Cl. CPC G06F 13/22; G07C 5/0816; B60K 35/00; B60K 2370/171; B60K 2370/157; B60K 2370/774; B60K 2370/166; B60K 2370/1529

(57) ABSTRACT

Embodiments described herein relate to systems and methods for conveying vehicle information according to a hierarchy of output devices. In one embodiment, a vehicle includes one or more output devices and a computing device communicatively coupled thereto. The computing device includes a processor, a non-transitory computer readable memory communicatively coupled to the processor, and computer readable instructions stored in the non-transitory computer-readable memory that, when executed by the processor, cause the system to detect the one or more output devices for conveying information in the vehicle, determine the hierarchy of using the one or more output devices, and convey information through the one or more output devices according to the hierarchy.

### TECHNICAL FIELD

The present specification generally relates to communication of information in a vehicle and more specifically, to systems and methods capable of conveying information in a vehicle according to a hierarchy of output devices.

### BACKGROUND

Current technologies provide for different computing devices (embedded systems) in different vehicle models and accessories. For instance, a vehicle with a head-up display (HUD) and a vehicle without a HUD require unique computing configurations. Therefore, a high-end vehicle with a HUD requires a different computing configuration than a low-end vehicle without a HUD. The differences in output device, such as displays, among vehicle models and trim levels require an automobile manufacturer to develop and maintain many different software programs to accommodate the different output devices. For example, a first vehicle model may require a first software program and a second vehicle model may require a second software program that, although similar to the first software program, is different because of different display capabilities between the first vehicle model and the second vehicle model. Developing and maintaining many different software program versions may be expensive and inefficient.

### SUMMARY

The present specification relates to systems and methods capable of conveying information in a vehicle according to a hierarchy of preferences. In one embodiment, a vehicle includes one or more output devices and a computing device communicatively coupled to the one or more output devices. The computing device includes a processor, a non-transitory computer readable memory communicatively coupled to the processor, and computer readable instructions stored in the non-transitory computer-readable memory that, when executed by the processor, cause the processor to perform a number of steps. The steps include detecting the one or more output devices for conveying information in the vehicle, determining a hierarchy of output devices, and conveying information through the one or more output devices according to the hierarchy.

In another embodiment, a system of conveying information in a vehicle according to a hierarchy of preferences is disclosed. The system includes a computing device communicatively coupled to one or more output devices. The computing device includes a processor, a non-transitory computer readable memory communicatively coupled to the processor, and computer readable instructions stored in the non-transitory computer-readable memory that, when executed by the processor, causes the processor to perform a number of steps. The steps include detecting the one or more output devices for conveying information in the vehicle, determining a hierarchy of output devices, and conveying information through the one or more output devices according to the hierarchy.

In yet another embodiment, a computer-implemented method of conveying information in a vehicle according to a hierarchy of output devices using a computing device is disclosed. The method includes the steps of detecting one or more output devices for conveying information in the vehicle, determining a hierarchy of output devices, and conveying information through the one or more output devices according to the hierarchy.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an interior of a vehicle having a number of output devices located therein, according to one or more embodiments shown and described herein;

FIG. 2 depicts a system of conveying information in a vehicle using the output devices depicted in FIG. 1, according to one or more embodiments shown and described herein; and

FIG. 3 depicts a flow chart of a computer-implemented method performed by the system of FIG. 2, according to one or more embodiments shown and described herein.

### DETAILED DESCRIPTION

Embodiments described herein relate to systems and methods capable of conveying information in a vehicle according to a hierarchy of preferences. In embodiments, computing devices (embedded systems) across vehicles of different models but same make include a common operating system having a universal software stack for providing a shared interface for invoking a software program capable of detecting available output devices for conveying information in the vehicle, and then presenting information related to vehicle component status, operation and navigation of the vehicle and the like, according to a hierarchy of preferences determined by the software program.

Different vehicle models have different display devices and capabilities. For example, a luxury model made by a vehicle manufacturer may have display capabilities that are different than the display capabilities of an economy model. The luxury model may have a heads-up display (HUD), a large console display, and a dashboard display, whereas the economy model may only have a dashboard display and a small console display. Further, different trim levels of the same vehicle model may have different displays and display capabilities.

Vehicles produce information and provide content that are displayed on the displays of the vehicle. Such content is displayed in a manner that is controlled by software. However, having multiple vehicles with multiple display configurations and capabilities means that the vehicle manufacturer must create and maintain multiple versions of software so that the information is displayed correctly according to the display capabilities of the particular vehicle.

Another complicating factor is some information is better suited displayed on one type of display device rather than another. For example, high priority information, such as an obstacle warning, may be better suited for display on a HUD than a console display. Thus, information may be prioritized, and displayed on the best-suited display device. However, some vehicles do not have all of the possible display devices, and, for example, information best suited for a particular display device that is not installed in a particular vehicle must be routed to another display device that is installed.

Embodiments of the present disclosure provide for systems, methods and vehicles for deploying one universal software stack (hereinafter “software”) into a fleet of vehicles comprising many models and trim levels and many different display configurations. Thus, the number of unique software versions required to be maintained by the manufacture is reduced. Generally, at run-time, the software controls one or more processors to detect the display and accessory configurations, and set an information display hierarchy based on the display and accessory configuration that is detected.

Various other aspects of the disclosure and variations thereof are illustrated or implied through the descriptions of the embodiments below.

As used herein, the following terms are generally defined in the manner below. The term “communicatively coupled” means that coupled components are capable of exchanging data signals with one another such as, for example, electrical signals via conductive medium, electromagnetic signals via air, optical signals via optical waveguides, and the like. The term “software stack” refers to a set of applications working in a specific and defined order toward a common objective. Additionally, it is noted that the term “signal” means a waveform (e.g., electrical, optical, magnetic, mechanical or electromagnetic) capable of traveling through a medium such as DC, AC, sinusoidal-wave, triangular-wave, square-wave, vibration, and the like, capable of traveling through a medium.

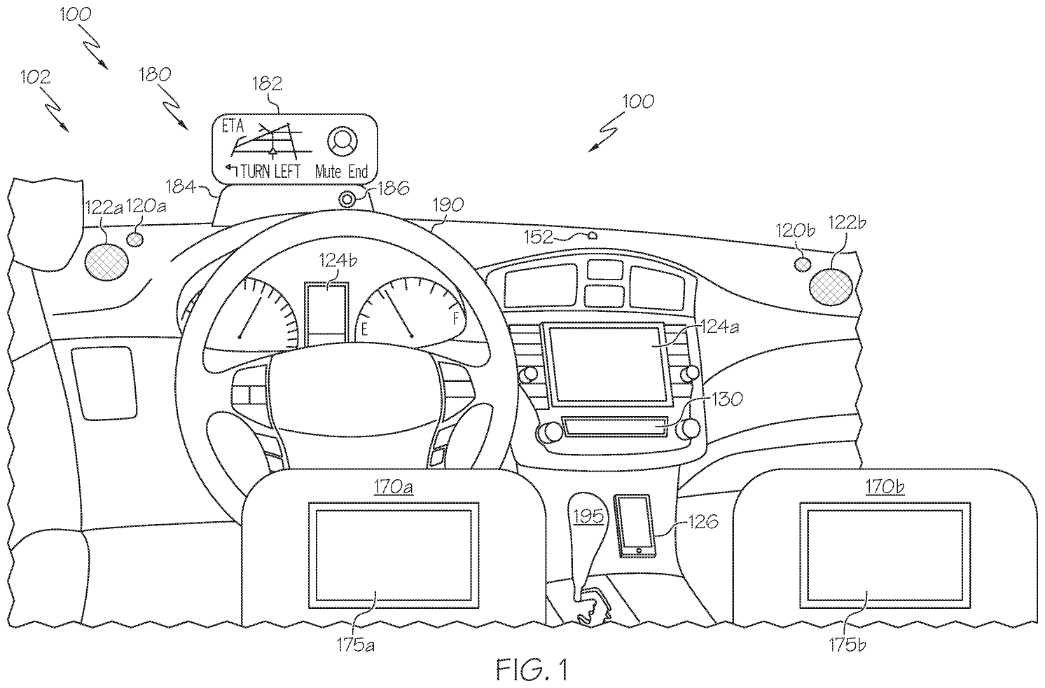

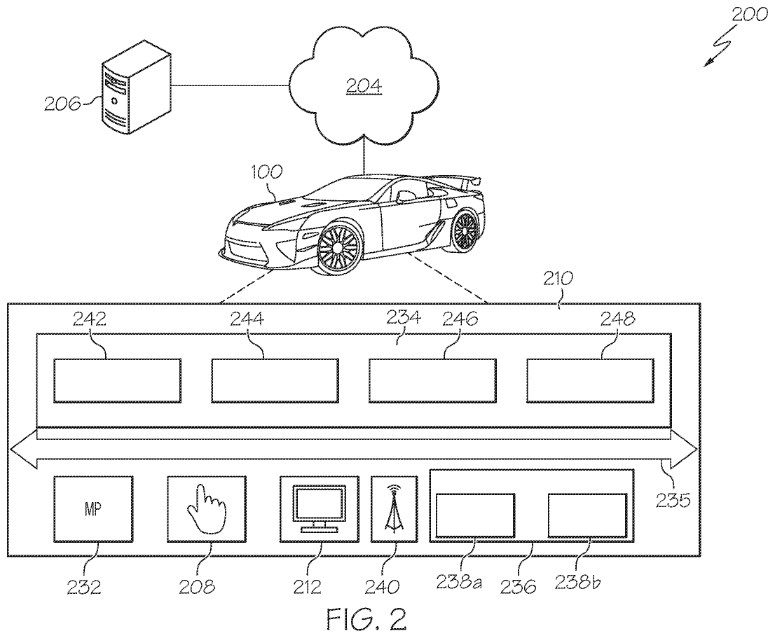

Referring now to the drawings, FIG. 1 schematically depicts an interior 102 of a vehicle 100 having a number of output devices 212 (shown in FIG. 2) located therein. The vehicle 100 depicted in FIG. 1 may be an automobile or any passenger or non-passenger vehicle such as, for example, a terrestrial, aquatic, and/or airborne vehicle. As illustrated, the interior 102 may include one or more output devices such as, but not limited to, a console display 124a, a dashboard display 124b, a mobile device 126, headrest display screens 175a and 175b, and a head-up display (HUD) display 180 (collectively “the output devices 212”). The vehicle 100 includes computing device 210 communicatively coupled to the output devices 212.

The computing device 210 (shown in FIG. 2) may be configured with one or more processors 232 and a memory component 234, which may store a plurality of different pieces of logic, each of which may be embodied as a computer program, firmware, and/or hardware, as an example. Additional components of the computing device 210 are depicted and described in greater detail with respect to FIG. 2.

In some embodiments, the console display 124a may be configured to provide one or more user interfaces, and may be configured as a touch screen and/or include other features for receiving user input. The dashboard display 124b positioned behind a steering wheel 190 may similarly be configured to provide one or more interfaces, but the data provided in the dashboard display 124b may be a subset of the data provided by the console display 124a, for example. Regardless, at least a portion of the user interfaces depicted and described herein may be provided on either or both the console display 124a and the dashboard display 124b.

The mobile device 126 may include any communications device. The mobile device 126 may include a mobile telephone, a tablet, a portable computer, a media file player, or other similar mobile device that is not permanently connected to the vehicle 100 and may be utilized for functionality outside of the vehicle 100. Thus, while the mobile device 126 is depicted as adjacent to the console display 124a of the vehicle 100, this is merely an example, as the mobile device 126 need only be in communication with the computing device 210 via near-field communication, wide area communication, and the like.

The headrest display screen 175a is mounted behind a driver seat headrest 170a and the headrest display screen 175b is mounted behind a passenger seat headrest 170b. The headrest display screens 175a, 175b may be commercially available display screens configured to output an image, a video or a multimedia file.

The example HUD 180 includes a display area 182, a projector 184, and an optional camera 186 mounted on the projector 184. The camera 186 may be configured to capture images of the interior and the exterior of the vehicle 100 to be subsequently projected by the projector 184 on the display area 182. The projector 184 of the HUD projects an image onto an interior surface of the windshield of the vehicle 100, which then reflects the image for viewing by an occupant.

The example interior 102 of the vehicle 100 further includes a content playback device 130, which may include a tape player, a compact disc player, a digital video disc player, a media file player, a radio signal receiver, a television signal receiver, an internet receiver, a navigation receiver, and the like. The content playback device 130 may be operated via a touch screen of the console display 124a, the dashboard display 124b, or one or more other inputs, such as on the steering wheel 190 of the vehicle 100. The content playback device 130, the console display 124a, and the dashboard display 124b are coupled to one or more microphones 120a, 120b and one or more speakers 122a, 122b. The one or more microphones 120a, 120b may be configured to receive user voice commands and other inputs. Similarly, the speakers 122a, 122b may be utilized for providing audio content from the content playback device 130 to a driver or passenger of the vehicle 100. The content playback device 130, the microphones 120a, 120b, the speakers 122a, 122b, and related components may represent a vehicle audio system.

The example interior 102 also includes a communication transceiver 152. The communication transceiver 152 is configured to facilitate communication between the different output devices 212 and the computing device 210. Depending on the particular embodiment, the communication transceiver 152 may be configured for a near-field wireless communication or other wired or wireless communication protocol for communicating with the computing device 210.

It should be understood that other vehicle makes and trims may have more, fewer, and/or different output devices than those shown in FIG. 1.

FIG. 2 depicts a system 200 of conveying information in the vehicle 100 using the output devices 212 depicted in FIG. 1. The system 200 includes the computing device 210 communicatively connected to a cloud server 206 through a communication network 204. As discussed above, the computing device 210 may include the one or more processors 232, the memory component 234, input devices 208, the output devices 212, network interface hardware 240, and a data storage component 236.

The communication network 204 may include a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

The one or more processors 232 may be any device capable of executing a machine-readable instruction set stored in the memory component 234. Accordingly, the processor 232 may be an electronic controller, an integrated circuit, a microchip, a computer, and the like. The processor 232 is communicatively coupled to the other components of the computing device 210 by the communication bus 235, which communicatively couples the processor 232 with the other components to operate in a distributed computing environment.

The memory component 234 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, the non-transitory computer-readable mediums may reside within or outside the computing device 210. The memory component 234 may be configured to store a machine-readable instruction set that can be accessed and executed by the processor 232. The machine-readable instruction set may comprise logic or algorithm(s) written in any programming language of any generation (e.g., 1GL, 2GL, 3GL, 4GL, or 5GL) such as, for example, machine language that may be directly executed by the processor 232, or assembly language, object-oriented programming (OOP), scripting languages, microcode, etc., that may be compiled or assembled into computer readable instructions and stored in the memory component 234. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The memory component 234 may store operating logic 242, device detection logic 244, communications logic 246, and display logic 248. The device detection logic 244 and the communications logic 246 may each include a plurality of different pieces of logic, each of which may be embodied as a computer program, firmware, and/or hardware, as an example. The device detection logic 244 may be configured to cause the computing device 210 to index content for the output devices 212 such that an order of use of the one or more output devices 212 may be determined. The communications logic 246 may be configured to cause the computing device 210 to facilitate communication with the output devices 212. The logic stored within the memory component 234 defines a universal software stack that may be deployed on a variety of vehicle models and trim levels, regardless of display capabilities. As described in more detail below, the logic defining the universal software stack determines

The communication bus 235 may be implemented as a bus or other communication interface to facilitate communication among the components of the computing device 210. Each of the components along the communication bus 235 may operate as a node that may send and/or receive data. The communication bus 235 is formed from any medium that is capable of transmitting a signal such as, for example, conductive wires, conductive traces, optical waveguides, or the like. The communication bus 235 may also refer to the expanse in which electromagnetic radiation and their corresponding electromagnetic waves traverses. Moreover, the communication bus 235 may be formed from a combination of mediums capable of transmitting signals. In one embodiment, the communication bus 235 comprises a combination of conductive traces, conductive wires, connectors, and buses that cooperate to permit the transmission of electrical data signals to and from the various components of the computing device 210. Accordingly, the communication bus 235 may comprise a bus, such as for example a LIN bus, a CAN bus, a VAN bus, and the like.

As described above, the input devices 208 may include and/or be configured to interface with the components of FIG. 2. As an example, the input devices 208 may include a touch-screen input of the console display 124, nobs, switches, microphones 120a, 120b, and any other input device provided in the vehicle 100.

The network interface hardware 240 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated among the computing device 210, the cloud server 206, and other devices and servers.

The data storage component 236 is configured to store local data 238a for the computing device 210 as well as any intermediate data 238b obtained by the processor 232. The data storage component 236 may also store device driver data 238c that correspond to the various output devices 212 within the vehicle 100. The device drivers within the device driver data 238c provide instruction on how the computing device 210 communications with the output devices 212, and also information regarding display capabilities (e.g., resolution). As a non-limiting example, the device driver data 238c may store information relating to all output devices provided in all vehicles across a vehicle fleet.

The cloud server 206 is communicatively connected to computing devices 210 of vehicles 100 having the same make across different models. Further, the cloud server 206 is configured to share and update the operating system 250 as well any machine-readable instruction set stored in the memory component 234 with vehicles 100 of same make.

It should be understood that while the components in FIG. 2 are illustrated as residing within the computing device 210, this is merely an example. In some embodiments, one or more of the components may reside external to the computing device 210 such as within the cloud server 206, and other devices and servers communicatively connected via the communication network 204. Additionally, while the computing device 210 is illustrated with the device detection logic 244 and the communications logic 246 as separate logical components, this is also an example. In some embodiments, a single piece of logic may cause the computing device 210 to provide the described functionality.

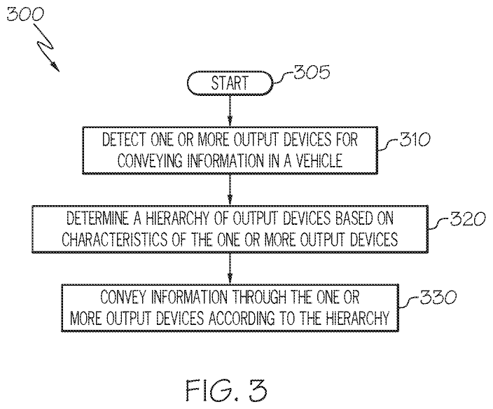

FIG. 3 depicts a flow chart of a computer-implemented method 300 performed by the system 200 of conveying information in the vehicle 100 using the output devices 212. The information may relate to operation of the vehicle (for example, accelerating or braking, consumption and availability of fuel, and the like), navigation of the vehicle (for example, distance and time to destination, exact route to destination, upcoming turns and tolls, and the like), status of vehicle components (for example, battery status, maintenance status), and other information such as weather, time, etc.

The method starts at block 305, which may be an ignition or start of a vehicle from an off state. For example, in an internal combustion engine, the start may be the ignition of the engine. In an electric vehicle, the start may be the pushing of a Start button awakening the vehicle from a sleep or off state. In some embodiments, the system 200 checks the output device 212 configuration at every start of the vehicle. In other embodiments, the system 200 performs method 300 only once at the initial start of the vehicle, such as at the factory. In yet other embodiments, the method 300 may be performed as part of software upgrade process. For example, a vehicle may download the universal software stack as part of an over-the-air software update process. After download and installation of the universal software stack, the processor may execute method 300 to establish how many and what type of output devices 212 are installed in the vehicle.

At block 310, the one or more output devices 212 for conveying information in the vehicle 100 is detected. The output devices 212 may be detected in a variety of ways. In one example, the processor 232 scans one or more buses of the computing device 210, such as, but not limited to, the communication bus 235 to detect the output devices 212 available in the vehicle 100. For example, the output devices 212 may communicate an identification code on the communication bus 235 (e.g., a CAN bus). The identification code provides information regarding what type of output device 212 it is. For example, a particular model of a HUD will have one unique identification code, while a particular model of a console display will have another identification code. Thus, each of the output devices 212 may be assigned a unique identification code, which may be as a numeric, alphabetic and/or alphanumeric sequence. The system 200 may store the identification codes, which can be used to look-up the type of output device and its device driver, for example. As a non-limiting example, a first identification code may detected by the processor 232 on the communication bus. The processor 232 may then compare the first identification code against identification codes stored in the data storage component 236. When the is a match, the processor 232 then determines the type of output device 212 associated with the matching identification code. The processor 232 may then apply a device driver or otherwise obtain information needed to communicate information with the determined output device 212.

The process is repeated until all output devices 212 employed by the vehicle are detected. There may be any number of detected output devices 212. These detected output devices may be stored in a list, for example.

It should be understood that the output devices 212 may be detected by other means than monitoring the communication bus 235. For example, the output devices 212 may directly communicate their presence and/or information to the processor 232 rather than reporting an identification code as described above.

At block 320, a hierarchy of preferences of using the one or more output devices 212 is determined. During this process, the processor 232 evaluates the capabilities of the output devices 212 available in the vehicle 100. The capabilities of each output device 212 may be provided in the device driver and/or the data storage component 236 may store the capabilities of all of the potential output devices 212 in a database. Capabilities include, but are not limited to, display type (e.g., light emitting diode (LED), seven-segment liquid crystal display (LCD), standard definition LCD, high definition LCD, QLED, display size, display resolution, location of output device in vehicle, HUD, touch screen, speaker, and the like. The data storage component 236 may also store capability rankings that are referenced when determining the hierarchy of output devices. In a non-limiting example, rankings of output devices may be determined by evaluating individual capabilities. For example, output devices may be scored on capabilities, and the processor may rank the available output devices 212 into a hierarchy based on score. Location of the output device 212 in the interior 102 may be one factor such that a location in the interior 102 where the driver frequently looks may have a score that his higher than another location in the vehicle cabin. In such an example, a HUD may have a higher location score than a console display because the driver more frequently looks at a HUD than a console display. There may be other capability scores, such as a resolution score, a display type score, a size score, and the like. All of the individual scores for an output device may be summed together to calculate an overall score. As a non-limiting example, the hierarchy of output devices may be based on the overall scores of the available output devices. In some embodiments, an overall score may be calculated for the type of information such that multiple hierarchies of output display devices are determined based on the type of information that is to be delivered to the driver. For example, emergency information may have a different hierarchy than general traffic information. Thus, emergency information may be prioritized on one output device while general traffic information is prioritized on another output device. In some embodiments, user preferences may also be used to determine a ranking of output devices such that the hierarchy also takes into account user preferences.

In embodiments, the processor 232 may determine that one or more output devices 212 may or may not be suitable for outputting high definition (HD) images and videos, graphics requiring faster download speeds, and/or interactive content. Based on such assessment of capabilities and/or user preferences indicated through the input devices 208, the processor 232 determines an order of use of the output devices 212. For example, depending on the content to be outputted, the HUD 180, if available in the vehicle 100 may be ranked higher in preference than the console display 124a and the console display 124a may be ranked higher in preference than the headrest display screens 175a and 175b.

At block 330, the information is conveyed through the one or more output devices 212 according to the hierarchy. Continuing with the preceding example, if a vehicle 100 having the HUD 180 is about to display a message to a driver of the vehicle 100, the processor 232 would determine that the HUD 180 is available, which is then used to display the message. Any information currently displayed on the console display 124a or a lesser-ranked display remains uninterrupted. Alternatively, if the vehicle 100 does not have a HUD 180 available, the processor 232 does not determine that the HUD 180 is available and thus proceeds to output the message on the next most preferred display, the console display 124a. Any information currently displayed on the headrest display screens 175a and 175b is not interrupted.

The systems described herein can be advantageously implemented across vehicles of different models within the same make in order to convey a variety of information according to a hierarchy of output devices. The use of an operating system having a universal software stack enables a single driver software module compatible with device drivers for individual output devices to detect the output devices and present relevant information, according to a hierarchy of output devices based on user preferences and capabilities of the individual output devices.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
one or more output devices; and
a computing device communicatively coupled to the one or more output devices, the computing device comprising:
a processor;
a non-transitory computer readable memory communicatively coupled to the processor, the non-transitory computer readable memory storing computer readable instructions that, when executed by the processor, cause the processor to:
detect the one or more output devices for conveying information in the vehicle;
determine a hierarchy of the one or more output devices; and
convey information through the one or more output devices according to the hierarchy.

2. The vehicle of claim 1, wherein the computer readable instructions further cause the processor to:
scan one or more buses of the computing device in the vehicle to detect the one or more output devices;
determine a presence of one or more device drivers corresponding to the one or more output device; and
configure the one or more output devices to convey information according to the one or more device drivers.

3. The vehicle of claim 1, wherein the one or more output devices comprises one or more of:
a head-up display (HUD), a console display, a dashboard display, a headrest display screen, a mobile device, and a speaker.

4. The vehicle of claim 1, wherein the computer readable instructions further cause the processor to:
evaluate one or more capabilities of the one or more output devices; and
determine the hierarchy of the one or more output devices based on one or more of user preferences and the one or more capabilities.

5. The vehicle of claim 1, wherein the information relates to one or more of: operation of the vehicle, navigation of the vehicle, and status of vehicle components.

6. The vehicle of claim 1, wherein the computer readable instructions is updated through a cloud server communicatively connected to computing devices installed in vehicles of same make.

7. A system of conveying information in a vehicle according to a hierarchy of preferences, the system comprising:
a computing device communicatively coupled to one or more output devices, the computing device comprising:
a processor;
a non-transitory computer readable memory communicatively coupled to the processor, the non-transitory computer readable memory storing computer readable instructions that, when executed by the processor, cause the processor to:
detect the one or more output devices for conveying information in the vehicle;
determine a hierarchy of the one or more output devices; and
convey information through the one or more output devices according to the hierarchy.

8. The system of claim 7, wherein the computer readable instructions further cause the processor to:
scan one or more buses of the computing device to detect the one or more output devices;
determine a presence of one or more device drivers corresponding to the one or more output device; and
configure the one or more output devices to convey information.

9. The system of claim 7, wherein the one or more output devices comprises one or more of:
a head-up display (HUD), a center stack display, a headrest display screen, a tablet, a mobile phone, and a speaker.

10. The system of claim 7, wherein the computer readable instructions further cause the processor to:
evaluate one or more capabilities of the one or more output devices; and
determine an order of use of the one or more output devices based on one or more of: user preferences and the one or more capabilities.

11. The system of claim 7, wherein the information relates to one or more of: operation of the vehicle, navigation of the vehicle, and status of vehicle components.

12. The system of claim 7, wherein the system is applicable on vehicles of same make.

13. The system of claim 7, wherein the computer readable instructions are updated through a cloud server communicatively connected to computing devices in vehicles of same make.

14. The system of claim 7 further comprising a cloud server communicatively coupled to the computing device, the cloud server configured to share and update the computer readable instructions with vehicles of same make.

15. A computer-implemented method of conveying information in a vehicle according to a hierarchy of output devices, the method comprising:
detecting one or more output devices for conveying information in the vehicle;
determining a hierarchy of the one or more output devices; and
conveying information through the one or more output devices according to the hierarchy.

16. The computer-implemented method of claim 15, wherein detecting one or more output devices comprises:
scanning one or more buses of in the vehicle to detect the one or more output devices;
determining a presence of one or more device drivers corresponding to the one or more output device; and
configuring the one or more output devices to convey information according to the one or more device drivers.

17. The computer-implemented method of claim 15, wherein the one or more output devices comprises one or more of: a head-up display (HUD), a console display, a dashboard display, a headrest display screen, a mobile device, and a speaker.

18. The computer-implemented method of claim 15, wherein determining a hierarchy of preferences comprises:
evaluating one or more capabilities of the one or more output devices; and
determining an order of use of the one or more output devices based on one or more of:
user preferences and the one or more capabilities.

19. The computer-implemented method of claim 15, wherein the information relates to one or more of: operation of the vehicle, navigation of the vehicle, and status of vehicle components.

20. The computer-implemented method of claim 15, further comprising updating one or more of a same make with computer readable instructions for conveying the information through the one or more output devices.
